(19) United States
(12) Patent Application Publication
(10) Pub. No.: US 2026/0159152 A1
(43) Pub. Date: Jun. 11, 2026

(54) CONFIGURABLE END-STOP MECHANISM FOR STEER-BY-WIRE ASSEMBLY

(71) Applicant: GHSP, INC., Holland, MI (US)

(72) Inventors: John Thomas Bagley, Grand Haven, MI (US); Jeffrey Lee Bays, Grand Haven, MI (US)

(73) Assignee: GHSP, INC., Holland, MI (US)

(21) Appl. No.: 19/404,092

(22) Filed: Dec. 1, 2025

Related U.S. Application Data
(60) Provisional application No. 63/730,510, filed on Dec. 11, 2024.

(51) Int. Cl. B62D 5/00; B62D 5/04

(52) U.S. Cl. CPC B62D 5/006; B62D 5/0409; B62D 5/0442

(57) ABSTRACT

A steering system for a vehicle includes a steering shaft that rotationally operates within a housing and is operable between a manual state and an idle state, and a ratchet assembly that selectively defines a first end stop of the steering shaft and a second end stop of the steering shaft. Conversion of the steering shaft from the idle state to the manual state causes the ratchet assembly to define respective locations of the first end stop and the second end stop relative to the housing. Further, the respective locations of the first end stop and the second end stop are based upon a position of a vehicular steering assembly relative to a vehicle frame and a rotational position of the steering shaft.

### CROSS-REFERENCE TO RELATED APPLICATION

This application claims priority to and the benefit under 35 U.S.C. § 119(e) of U.S. Provisional Patent Application No. 63/730,510, filed on Dec. 11, 2024, entitled CONFIGURABLE END-STOP MECHANISM FOR STEER-BY-WIRE ASSEMBLY, the entire disclosure of which is hereby incorporated herein by reference.

### FIELD OF THE DISCLOSURE

The present disclosure generally relates to a steering interface, and more specifically, a configurable end-stop mechanism for use with a steer-by-wire assembly that can configure and reconfigure the position of end stops for the steering interface.

### BACKGROUND OF THE DISCLOSURE

Within vehicles, a steering wheel is typically used for operating a steering assembly for the vehicle. As the user drives the vehicle, the steering wheel rotates clockwise and counterclockwise to operate the steering assembly. To indicate that the steering assembly has reached a maximum turning position to the left or to the right, the steering wheel includes end stops that prevent further rotation of the steering wheel in each of the clockwise and counterclockwise directions.

### SUMMARY OF THE DISCLOSURE

According to one aspect of the present disclosure, a steering system for a vehicle includes a steering shaft that rotationally operates within a housing and is operable between a manual state and an idle state, and a ratchet assembly that selectively defines a first end stop of the steering shaft and a second end stop of the steering shaft. Conversion of the steering shaft from the idle state to the manual state causes the ratchet assembly to define respective locations of the first end stop and the second end stop relative to the housing. Further, the respective locations of the first end stop and the second end stop are based upon a position of a vehicular steering assembly relative to a vehicle frame and a rotational position of the steering shaft.

According to another aspect of the present disclosure, a steering system for a vehicle includes a steering shaft that rotationally operates within a housing and is operable between a manual state and an idle state, a first ratchet member that selectively defines a first end stop of the steering shaft, and a second ratchet member that selectively defines a second end stop of the steering shaft. Conversion of the steering shaft from the idle state to the manual state causes the first ratchet member and the second ratchet member to define the first end stop and the second end stop. Further, respective locations of the first end stop and the second end stop are based upon a position of a steering assembly and a rotational position of the steering shaft.

According to another aspect of the present disclosure, a steering system for a vehicle includes a steering shaft that rotationally operates to control a motor of a steer-by-wire assembly, a first ratchet portion of a ratchet assembly that selectively defines a first end stop of the steering shaft, a second ratchet portion of the ratchet assembly that selectively defines a second end stop of the steering shaft, and a pawl assembly that operates relative to the ratchet assembly to define the first end stop and the second end stop, respectively. A controller operates the pawl assembly based upon an operational parameter to define the first end stop and the second end stop. The operational parameter includes at least one of vehicle speed, a security setting, and a condition surrounding the vehicle.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic diagram illustrating a vehicle that incorporates a steer-by-wire assembly and an aspect of the ratchet assembly for configuring the position of end stops for the steering interface;

FIG. 2 is a schematic diagram illustrating components of a steer-by-wire assembly that includes an aspect of the ratchet assembly;

FIG. 3 is a perspective view of an aspect of a ratchet assembly that includes opposing pawls that are used to selectively define first and second end stops of the steering shaft for operating the steer-by-wire assembly;

FIG. 4 is a schematic cross-sectional view of an aspect of a steering shaft showing operation of the pawl assembly to define the end stops for the steering assembly;

FIG. 5 is a schematic diagram illustrating operation of the reconfigurable ratchet assembly for defining and redefining the end stops of the steering shaft as the steering assembly shifts between a manual state and an idle state, where the steering interface is shown in a home position and the steering assembly in a forward position;

FIG. 6 is a schematic diagram illustrating operation of the reconfigurable ratchet assembly of FIG. 5, with the steering assembly in a left turn position, and the steering wheel in an idle state and in the home position;

FIG. 7 is a schematic diagram illustrating operation of the reconfigurable ratchet assembly of FIG. 6, with the steering wheel in the manual state, the steering assembly in the forward position, and the steering wheel in a new home position;

FIG. 8 is a schematic diagram illustrating operation of the reconfigurable ratchet assembly in a low speed setting defining a broad operational path of the first and second end stops during use of the steering assembly in the manual state;

FIG. 9 is a schematic diagram illustrating operation of the reconfigurable ratchet assembly in a high speed setting defining a narrowed operational path of the first and second end stops during use of the steering assembly in the manual state;

FIG. 10 is a schematic diagram illustrating operation of the reconfigurable ratchet assembly in an obstruction avoidance setting for defining an operational path of the first and second end stops to avoid a sensed obstruction;

FIG. 11 is a linear flow diagram illustrating a method for operating a steering assembly between a manual state and an idle state;

FIG. 12 is a linear flow diagram illustrating a method for operating a steering assembly at different vehicle speeds; and

FIG. 13 is a linear flow diagram illustrating a method for operating a steering assembly with respect to sensed obstructions relative to the vehicle.

The components in the figures are not necessarily to scale, emphasis being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

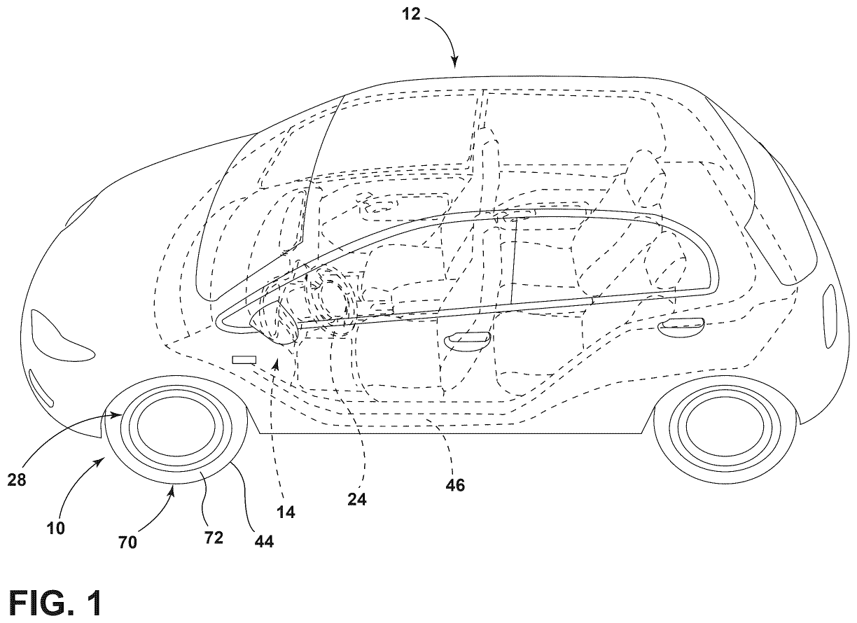

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a configurable end-stop mechanism for a steer-by-wire assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

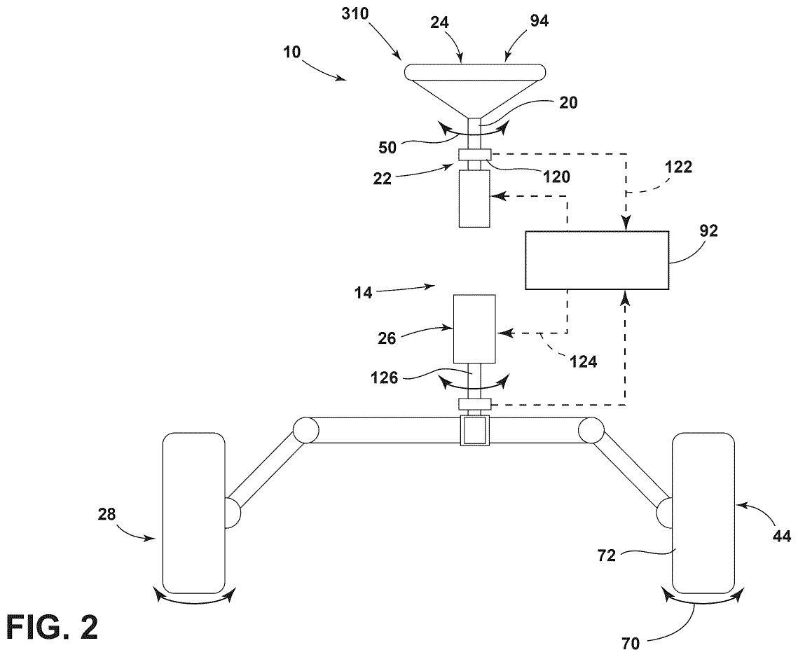

Referring to FIGS. 1-7, reference 10 generally refers to a steering assembly for a vehicle 12, where the steering assembly 10 is incorporated within a steer-by-wire assembly 14. The steering assembly 10 and the steer-by-wire assembly 14 are incorporated within a vehicle steering system. According to the various aspects of the device, the steering assembly 10, which may be autonomous capable, can shift between a manual state 16 and an idle state 18. The steering assembly 10 includes a steering shaft 20 that rotationally operates within a housing 22. The steering shaft 20 is operable between the manual state 16, where the user operates the steering assembly 10 by direct engagement with a steering wheel or other steering interface 24, and an idle state 18 that disengages the steering interface 24 from the steering assembly 10 and where a motor 26 is attached to at least one directional wheel 44 of a plurality of road wheels 28 or tires of the vehicle 12 to operate the steering assembly 10 for controlling the directional operation of the vehicle 12. In the idle state 18, the steering interface 24 is generally deactivated and does not control the operation of the steering assembly 10 of the vehicle 12. A ratchet assembly 30 is coupled with the steering shaft 20. The ratchet assembly 30 selectively defines a first end stop 32 of the steering shaft 20 and a second end stop 34 of the steering shaft 20. As described herein, the first end stop 32 of the steering shaft 20 defines a first maximum rotational position 36 of the directional wheels 44 of the steering assembly 10 in a clockwise direction 38 or counterclockwise direction 40. The second end stop 34 defines a second maximum rotational position 42 of the directional wheels 44 of the steering assembly 10 in the other of the clockwise direction 38 and counterclockwise direction 40.

Referring again to FIGS. 1-7, it is also contemplated that the steering assembly 10 can operate to modify the first end stop 32 and the second end stop 34 during operation of the vehicle 12. Such reconfiguration of the first end stop 32 and the second end stop 34 can occur through analysis and evaluation of certain operational parameters 52. Such operational parameters 52 can be used to dictate an operational path 50 of the steering shaft 20 through periodic reconfiguration of the first end stop 32 and the second end stop 34. By way of example, and not limitation, these operational parameters 52 can include, but are not limited to, vehicle speed, a security setting, or the position or orientation of the vehicle 12 with respect to a particular terrain with respect to horizontal or with respect to another condition surrounding the vehicle 12, combinations thereof and other similar operational parameters 52.

Referring again to FIGS. 1-7, as described herein, the steering shaft 20 and the steering assembly 10 can be converted from the manual state 16 to the idle state 18 as an autonomous driving mode is activated and deactivated. As described herein, where the idle state 18 is utilized, it can be understood that the vehicle 12 is in an autonomous driving mode. Where the steering shaft 20 is converted from the idle state 18 to the manual state 16, this conversion causes the ratchet assembly 30 to define respective positions of the first end stop 32 and the second end stop 34 relative to the housing 22 that surrounds the steering shaft 20 and a rotational orientation 70 of the directional wheels 44 of the steering assembly 10. It is contemplated that the respective locations of the first end stop 32 and the second end stop 34 are based upon the rotational orientation 70 of the directional wheels 44 for the vehicular steering assembly 10 and a rotational position 94 of the steering shaft 20. As described herein, the steering assembly 10 is coupled with a steer-by-wire assembly 14 that operates at least one motor 26 for modifying the rotational orientation 70 of certain directional wheels 44 of the vehicle 12 relative to the frame 46 of the vehicle 12. Typically, the steer-by-wire assembly 14 operates at least one directional wheel 44 of the vehicle 12. Typically, the directional wheels 44 are the two front wheels 72 of the vehicle 12. It is also contemplated that the steer-by-wire assembly 14 can operate all four road wheels 28 of the vehicle 12 through a single motor 26, or through multiple motors 26 that can each operate one road wheel 28 or can operate multiple road wheels 28 of the vehicle 12, such as the two front wheels 72, typically defining the directional wheels 44.

According to the various aspects of the device, as exemplified in FIGS. 1-7, when the steering assembly 10 shifts from the manual state 16 to the idle state 18, the directional wheels 44 of the vehicle 12 are in a particular rotational orientation 70. The steering interface 24 for the vehicle 12 corresponds to the same rotational orientation 70 of the directional wheels 44 for the vehicle 12 at the moment of this conversion from the manual state 16 to the idle state 18. After this conversion, an autonomous driving mode of the vehicle 12 will operate the motors 26 to manipulate the road wheels 28, including the directional wheels 44, as needed for operating the vehicle 12. At the same time, during the idle state 18, the steering interface 24 remains idle and typically in a fixed rotational position 94, or freely operable but disengaged from the steering assembly 10.

When the autonomous driving mode is deactivated and the vehicle 12 converts from the idle state 18 back to the manual state 16, the directional wheels 44 for the vehicle 12 may be at a different rotational orientation 70 as compared to when the steering assembly 10 and the steering interface 24 convert from the manual state 16 to the idle state 18. Accordingly, the position of the steering interface 24 may no longer correspond to the current rotational orientation 70 of the directional wheels 44 for the vehicle 12. To rectify this condition, the ratchet assembly 30 includes a pawl assembly 150, having at least one pawl 180, 184, that interacts with a ratchet member 90 for redefining the first and second end stops 32, 34 for the steering shaft 20. Stated another way, when the steering shaft 20 and/or the steering interface 24 convert from the idle state 18 to the manual state 16, the ratchet assembly 30, via a controller 92, determines the rotational orientation 70 of the directional wheels 44 for the vehicle 12 as well as the current rotational position 94 of the steering interface 24 for operating the steer-by-wire assembly 14. The ratchet assembly 30 reconfigures the rotational positions 94 of the first end stop 32 and the second end stop 34 to correspond to the relative positions of the directional wheels 44 for the vehicle 12 and the steering interface 24 for the steer-by-wire assembly 14. This reconfiguration of the first and second end stops 32, 34, as described herein, provides for an immediate conversion and reconfiguration of the steering interface 24 from the idle state 18 to the manual state 16 that is not readily perceived by the user.

In operation, when the user operates the steering interface 24 after the conversion from the idle state 18 to the manual state 16, the user will rotate the steering interface 24 toward one of the first end stop 32 or the second end stop 34. As the user rotates the steering interface 24, a sensing device 120 monitors the rotational position 94 of the steering interface 24. When the sensing device 120 senses that the steering interface 24 has reached either of the first end stop 32 or the second end stop 34, the pawl assembly 150 engages the ratchet member 90 to stop further rotation beyond either of the first end stop 32 or the second end stop 34. In this manner, the ratchet assembly 30 reconfigures the rotational positions of the first end stop 32 and the second end stop 34 to accommodate the new relative positions of the steering assembly 10 and the steering interface 24.

According to various aspects of the device, as exemplified in FIGS. 1-4, the steer-by-wire assembly 14 can include the steering shaft 20 that is attached to a steering field sensor, a feedback motor, or other similar rotational position sensing device 120. This sensing device 120 is attached to the controller 92. The controller 92, in turn, is also attached to the various motors 26 for the directional wheels 44 of the steering assembly 10. Operation of the steering shaft 20 is converted into position signals 122 that are delivered by the sensing device 120 to the controller 92. From the controller 92, command signals 124 are delivered to the one or more motors 26 of the steering assembly 10. Accordingly, in the steer-by-wire assembly 14, there is no direct physical connection between the steering shaft 20 and the steering assembly 10. Rather, the controller 92 receives the position signals 122 from the sensing device 120 and converts the position signals 122 into operative command signals 124 that are delivered to the one or more motors 26 of the steering assembly 10. The motor 26 then operates a drive shaft 126 of the steering assembly 10 to change the rotational orientation 70 of the road wheels 28 for the steering assembly 10 based upon the directions provided by the steering shaft 20.

As described herein, the steer-by-wire assembly 14 can include a single motor 26 that operates two front directional wheels 44. Alternatively, each of the two front directional wheels 44 can include a dedicated motor 26. In certain aspects of the device, each of the road wheels 28 of the vehicle 12 can include a dedicated motor 26, each having a dedicated drive shaft 126 that can be used to steer each directional wheel 44, respectively, to accomplish various navigation maneuvers of the vehicle 12.

According to the various aspects of the device, the ratchet assembly 30 includes the pawl assembly 150 that operates to define and redefine the first end stop 32 and the second end stop 34 of the steering shaft 20. The pawl assembly 150 operates to selectively engage the ratchet member 90 of the ratchet assembly 30. During operation, the pawl assembly 150 selectively engages the ratchet member 90 of the ratchet assembly 30 when the steering shaft 20 reaches the first end stop 32, and, additionally, when the steering shaft 20 reaches the second end stop 34. When the pawl assembly 150 engages the ratchet member 90, the steering shaft 20 is prevented from moving farther in the clockwise direction 38 or the counterclockwise direction 40, as the case may dictate. Additionally, in the case of the idle state 18, the pawl assembly 150 can fix the steering interface 24 in a fixed rotational position 94. Accordingly, in the manual state 16, the steering shaft 20 can freely rotate about a rotational axis within the housing 22 and between the first end stop 32 and the second end stop 34. When the steering shaft 20 reaches rotational positions 94 that correspond to the first and second maximum rotational positions 36, 42 of the one or more directional wheels 44 of the steering assembly 10, the pawl assembly 150 engages to define the respective first end stop 32 and the second end stop 34, respectively, of the steering shaft 20. Through this mechanism, the first end stop 32 and the second end stop 34 can be continuously and repeatedly reconfigured depending upon the relative positions of the directional wheels 44 of the steering assembly 10 and the steering interface 24 for operating the steering shaft 20 and the steer-by-wire assembly 14.

According to the various aspects of the device, as exemplified in FIGS. 1-7, the controller 92 is in communication with the steering shaft 20, the at least one motor 26 for the vehicular steering assembly 10, and the pawl assembly 150. The controller 92 operates the pawl assembly 150 relative to the ratchet member 90 of the steering shaft 20 to define the first end stop 32 and the second end stop 34, respectively. It is contemplated that the controller 92 can engage the pawl assembly 150 with the ratchet member 90 in the idle state 18 of the steering interface 24 to fix the rotational position 94 of the steering shaft 20 relative to the housing 22.

During operation of the vehicle 12 in the idle state 18, the plurality of road wheels 28, including the directional wheels 44, of the vehicle 12 will continuously operate as needed to operate the vehicle 12 from one location to another. As noted previously, the relative positions of the directional wheels 44 of the vehicle 12 with respect to the steering interface 24 for the steering shaft 20 and the steer-by-wire assembly 14 may change each time the steering assembly 10 and the steering interface 24 convert between the manual state 16 and the idle state 18. At each of these conversion points, the first end stop 32 and the second end stop 34 of the steering interface 24 may need to be reconfigured based upon the updated relative positions of the directional wheels 44 of the vehicle 12 with respect to the steering interface 24 for the steer-by-wire assembly 14.

According to the various aspects of the device, the steering interface 24 is typically in the form of a steering wheel that the user can selectively operate in the manual state 16 for controlling the direction of the vehicle 12. It is contemplated that other steering interfaces 24 may be utilized that may not be wheel shaped, but nonetheless provide for operation of the steer-by-wire assembly 14 and, in turn, the directional orientation of the one or more directional wheels 44 of the vehicle 12.

According to the various aspects of the device, the pawl assembly 150 can include a first pawl 180 that selectively engages a first portion 182 of the ratchet member 90 to define the first end stop 32. The pawl assembly 150 can also include a second pawl 184 that selectively engages a second portion 186 of the ratchet member 90 to define the second end stop 34. In such an aspect of the device, the ratchet member 90, and, in particular, the first and second portions 182, 186 of the ratchet member 90, can include opposing toothed portions that selectively receive, respectively, the first pawl 180 and the second pawl 184. The first portion 182 of the ratchet member 90 can provide for rotational operation in a clockwise direction 38 and selectively prevent rotation of the steering shaft 20 in a counterclockwise direction 40 based upon interaction with the first pawl 180. The second pawl 184 can interact with the second portion 186 of the ratchet member 90 to allow for rotation of the steering shaft 20 in a counterclockwise direction 40 and selectively prevent rotation of the steering shaft 20 in a clockwise direction 38 based upon interaction with the second pawl 184 with the second portion 186 of the ratchet member 90. Both the first and second pawls 180, 184 can be used to engage the ratchet member 90 to prevent rotation of the steering shaft 20 in the idle state 18. Additionally, during typical operation, one of the first pawl 180 and the second pawl 184 engages the first portion 182 of the ratchet member 90 and the second portion 186 of the ratchet member 90, respectively, to alternatively define the first end stop 32 and the second end stop 34 of the steering shaft 20. The ratchet member 90 includes the first ratchet portion 182 that engages the first pawl 180 in a first rotational direction, such as the clockwise direction 38 or the counterclockwise direction 40, to selectively define the first end stop 32. The ratchet member 90 also includes the second ratchet portion 186 that engages the second pawl 184 in a second rotational direction, that is opposite the first rotational direction, to selectively define the second end stop 34, the second rotational direction being the other of the clockwise direction 38 or the counterclockwise direction 40.

According to various aspects of the device, the pawl assembly 150 can include the first pawl 180 and the second pawl 184, as discussed herein. It is also contemplated that the pawl assembly 150 can include a single pawl that can be used to engage dedicated portions of the ratchet member 90 to define the first end stop 32 and the second end stop 34. In this manner, the pawl may be a single pawl having different portions that can engage respective areas of the ratchet member 90 to define the first end stop 32 and the second end stop 34. It is also contemplated that the ratchet member 90 can take the form of two separate portions, as described herein, that can provide for free rotation of the steering shaft 20 in one direction, but selectively stopping engagement in the opposing rotational direction.

According to the various aspects of the device, the ratchet member 90 can be attached to an outer surface 202 of the steering shaft 20. In such an aspect of the device, actuators 204 of the pawl assembly 150 can be attached to an inner surface 206 of the housing 22 for operating the pawl assembly 150 relative to the ratchet member 90. These actuators 204, which can be part of an actuating assembly of the ratchet assembly 30, can operate the pawl assembly 150 through a rotational operation of each pawl, linear activation of each pawl, combination of linear and rotational operations of each pawl, and other similar operational movements.

In certain aspects of the device, it is contemplated that the ratchet member 90 can be engaged with the inner surface 206 of the housing 22 and the pawl assembly 150 can be attached to certain portions of the steering shaft 20 for extending outward to engage the ratchet member 90 of the ratchet assembly 30.

According to the various aspects of the device, as exemplified in FIGS. 1-7, the steering assembly 10 for the vehicle 12 can include the steering shaft 20 that rotationally operates within the housing 22. The steering interface 24 and the steering assembly 10 can operate between the manual state 16 and the idle state 18. A first ratchet member 230 selectively defines a first end stop 32 of the steering shaft 20. A second ratchet member 232 selectively defines a second end stop 34 of the steering shaft 20. It is contemplated that the first ratchet member 230 and the second ratchet member 232 can be coupled with one another or can be positioned distally from one another relative to the steering shaft 20 and the housing 22 that surrounds the steering shaft 20. Conversion of the steering shaft 20 and/or the steering interface 24 from the idle state 18 to the manual state 16 causes the first ratchet member 230 and the second ratchet member 232 to define and, as described herein, redefine the first end stop 32 and the second end stop 34. It is contemplated that the locations of the first end stop 32 and the second end stop 34 can be based upon the relative rotational orientation 70 of the directional wheels 44 for the steering assembly 10 and a rotational position 94 of the steering shaft 20.

As described herein, the ratchet assembly 30 can include the first ratchet member 230 that is a first toothed gear. The first pawl 180 can be included and is operable for selectively engaging the first toothed gear when the steering shaft 20 reaches a rotational position 94 to be defined as the first end stop 32. Similarly, the second ratchet member 232 is a second toothed gear. The second pawl 184 is operable for selectively engaging the second toothed gear when the steering shaft 20 reaches a rotational position 94 that is indicative of the second end stop 34. As described herein, a controller 92 operates the pawl assembly 150, or the first pawl 180 and the second pawl 184, by monitoring the rotational position 94 of the steering shaft 20 relative to the rotational orientation 70 of the directional wheels 44 for the steering assembly 10. When the steering shaft 20 reaches a rotational position 94 that is indicative of a maximum turn to the right turn position 314 (first maximum rotational position 36) or a maximum turn to the left turn position 316 (second maximum rotational position 42), the controller 92 operates the pawl assembly 150 for engaging the ratchet assembly 30 to define the first end stop 32 or the second end stop 34, respectively.

Again, as described herein, the relative positions of the directional wheels 44 for the steering assembly 10 of the vehicle 12 with respect to the steering shaft 20 can change as the steering shaft 20 and/or the steering interface 24 convert between the manual state 16 and the idle state 18. Each time this conversion occurs, the controller 92 monitors the relative positions of the directional wheels 44 for the steering assembly 10 and the steering shaft 20 to redefine the rotational positions 94 of the first end stop 32 and the second end stop 34.

The controller 92 is in communication with the steering shaft 20, the steering assembly 10, the first pawl 180, and the second pawl 184. The controller 92 operates at least one of the first pawl 180 and the second pawl 184 to define the first end stop 32 and the second end stop 34, respectively.

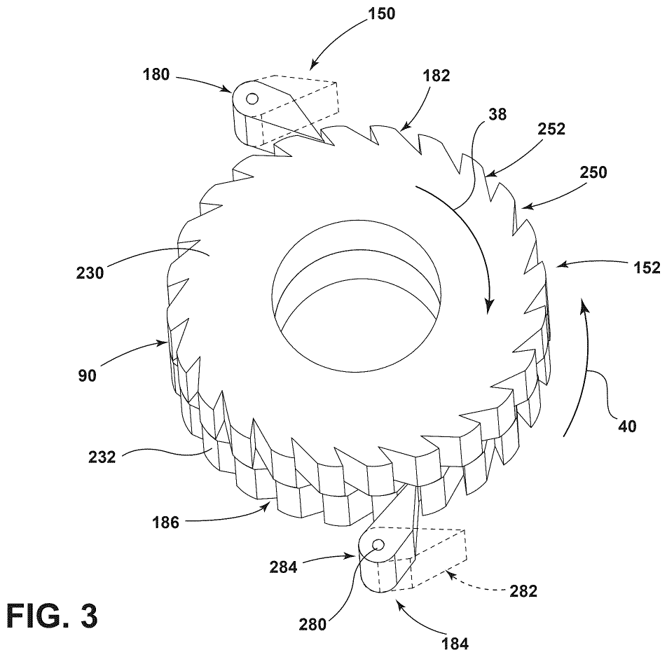

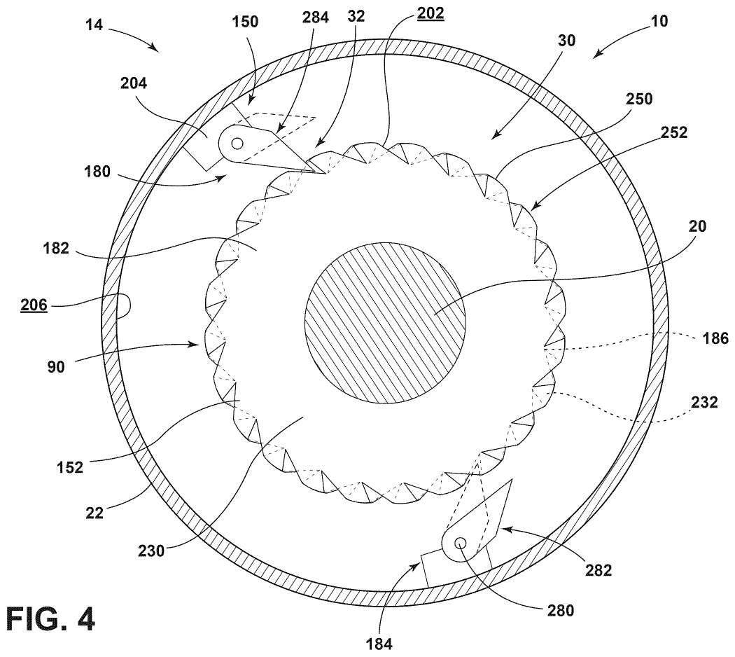

As exemplified in FIGS. 3-4, the ratchet member 90 typically includes teeth 250 that are positioned at an angular orientation 252. This angular orientation 252 provides for free rotation of the ratchet member 90 with respect to a corresponding pawl of the pawl assembly 150. When the ratchet member 90 reaches a particular rotational orientation indicative of the first end stop 32 or the second end stop 34, the pawl engages the angled teeth 250 of the ratchet member 90 to bind the ratchet member 90 and prevent further rotation in a particular direction. While the pawl is engaged, the ratchet member 90 may be freely rotated in the opposing rotational direction. As described herein, the ratchet member 90 includes ratchet portions that provide for this interface of the ratchet assembly 30 and the ratchet member 90 in each of the clockwise direction 38 and the counterclockwise direction 40.

In certain aspects of the device, it is contemplated that the first and second pawls 180, 184 engage the respective ratchet member 90 of the ratchet assembly 30 only when the first and second end stops 32, 34 are reached. It is also contemplated that the first and second pawls 180, 184 may engage the ratchet assembly 30 through a certain portion of the operational path 50 of the steering shaft 20. In these various configurations, and as described herein, rotation of the steering shaft 20 in the manual state 16 is generally free between the first and second end stops 32, 34.

According to the various aspects of the device, the pawl assembly 150 having the individual first and second pawls 180, 184 can operate relative to the ratchet member 90 in any one of various motions. Typically, the first and second pawls 180, 184 will rotate about a pawl axis 280 between a disengaged position 282 that is distal from the ratchet member 90 to an engaged position 284 that engages the angled teeth 250 of the ratchet member 90 to prevent rotation of the steering shaft 20 in a dedicated rotational direction. It is contemplated that the first and second pawls 180, 184 can be operated in any one of various rotations, as described herein.

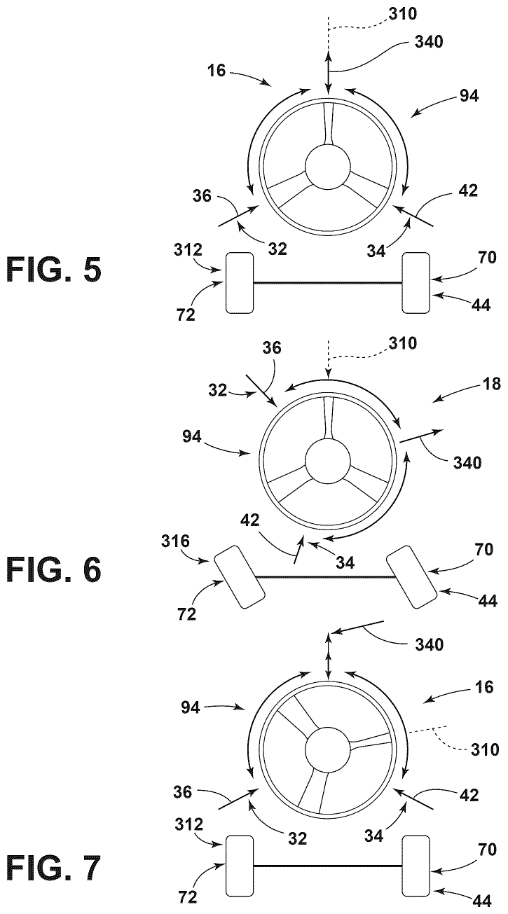

Referring now to FIGS. 5-7, operation of the steering system for the vehicle 12 is exemplified in diagrammatic form. According to FIG. 5, the steering interface 24 is positioned in a home position 310 or a center of rotation of the steering interface 24 pointing vertically. In this home position 310, the directional wheels 44 of the steering assembly 10 are positioned in a forward position 312 or orientation to direct the vehicle 12 in a straight path. FIG. 5 also indicates the moment that the steering assembly 10 and the steering interface 24 convert from the manual state 16 to the idle state 18.

FIG. 6 shows a later condition of the vehicle 12 after the vehicle 12 has been operated in the idle state 18. In this condition, the steering interface 24 remains in the home position 310. Contemporaneously, the directional wheels 44 of the steering assembly 10 are turned to the left turn position 316 or the right turn position 314. In this instance, the relative positions of the directional wheels 44 for the steering assembly 10 and the steering shaft 20, with respect to the frame 46 of the vehicle 12, have changed. At this point, the vehicle 12, in particular the steering interface 24, is converted from the idle state 18 to the manual state 16. During this conversion, the first end stop 32 and the second end stop 34 are reconfigured to match the respective positions of the directional wheels 44 for the steering assembly 10. Accordingly, as shown in FIG. 6, the first end stop 32, the second end stop 34, and the position of the central position 340 of the steering interface 24 have converted and shifted in a clockwise direction 38.

FIG. 7 shows the reconfigured positions of the first end stop 32 and the second end stop 34 from FIG. 6 and shows operation of the vehicle 12 in a straight direction. Accordingly, the relative position of the steering shaft 20 with respect to the directional wheels 44 of the steering assembly 10 has changed such that a new home position 310 has been redefined with respect to the steering shaft 20. This reconfigured home position 310, as shown in FIG. 7, does not correspond to the central position 340 of the steering interface 24.

According to various aspects of the device, it is contemplated that the vehicle 12, in a stationary position, can undergo a recalibration of the steering shaft 20 with respect to the directional wheels 44 of the steering assembly 10. Accordingly, in this recalibration operation, the steering shaft 20 can be returned to the home position 310 such that the central position 340 of the steering shaft 20 corresponds to the straight position of the directional wheels 44 for the steering assembly 10. Such a recalibration could occur when the vehicle 12 is stopped, in a park position, or other similar situations where the vehicle 12 is in a substantially stationary condition.

According to the various aspects of the device, use of the steering system described herein provides for conversion of the steering interface 24 of the vehicle 12 from the manual state 16 to the idle state 18 at any point during operation of the vehicle 12. It is generally preferred that the steering interface 24 remain stationary during the idle state 18 to prevent portions of the steering interface 24 from physically engaging a user of the vehicle 12. When the user desires that the vehicle 12 return to the manual state 16, it is frequent that the relative position of the steering shaft 20 does not match the rotational orientation 70 of the directional wheels 44 for the steering assembly 10. Accordingly, the ratchet assembly 30 described herein provides for an immediate reconfiguration of the first end stop 32 and the second end stop 34 of the steering shaft 20. Using the ratchet assembly 30, the user can immediately engage the manual state 16 without any perceptible movement of the steering shaft 20 during this conversion. Accordingly, the ratchet assembly 30 provides for an on-the-fly conversion of the steering shaft 20 and/or the steering interface 24 from the idle state 18 to the manual state 16 without any sort of rotational recalibration of the steering shaft 20 itself. Only the ratchet assembly 30 performs a recalibration or reorientation of the first end stop 32 and the second end stop 34 that is generally imperceptible by the user of the vehicle 12. Accordingly, the ratchet assembly 30 for the steering shaft 20 can define and redefine a home position 310 of the steering shaft 20, the first end stop 32 of the steering shaft 20, and the second end stop 34 of the steering shaft 20. These end stops 32, 34 and the home position 310 can be configured and reconfigured at any time during the conversion of the steering shaft 20 and/or the steering interface 24 from the idle state 18 to the manual state 16. Additionally, the idle position or lock position of the steering interface 24 can be any rotational position 94 of the steering interface 24 when the steering interface 24 converts from the manual state 16 to the idle state 18.

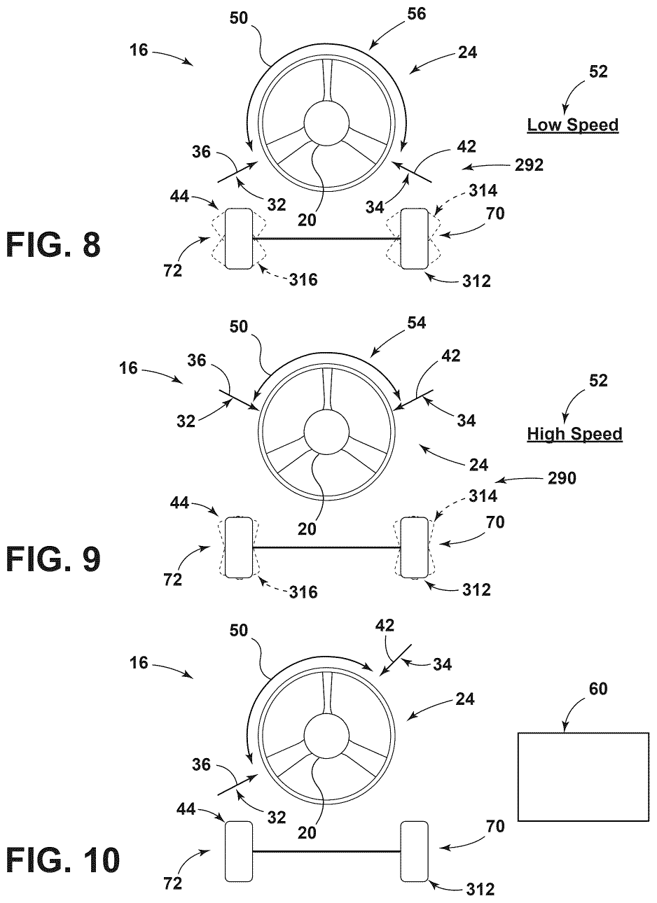

Referring now to FIGS. 8-10, it is contemplated that the ratchet assembly 30 that is used in combination with the steer-by-wire assembly 14 can be operated during the manual state 16 of operation. In this configuration, the pawl assembly 150 can be operated to manipulate, or reconfigure, or otherwise modify the locations of the first end stop 32 and the second end stop 34. This modification of the first end stop 32 and the second end stop 34 may be desired where full operation of the steering shaft 20 may not be desired. By way of example, and not limitation, the pawl assembly 150 can be operated in relation to the ratchet assembly 30 for preventing over-rotation of the steering shaft 20 when certain operational parameters 52 are present. These operational parameters 52 can include, but are not limited to, vehicle speed, a security setting, or certain conditions that are present around the vehicle 12. Typically, the operational parameters can include at least one of these conditions present relative to the vehicle 12.

Referring again to FIGS. 1-4 and 8-9, where the vehicle 12 operates at a high speed setting 290, it may become desirable to limit the operational path 50 of the steering shaft 20 to be within a more narrowed range 54 (shown in FIG. 9). When the vehicle 12 travels at a higher rate of speed, it is typical that the vehicle 12 is steered in very minute operations, such as changing lanes, steering through gentle curves, and other similar subtle navigational changes. Conversely, when a vehicle 12 travels at a slower rate of speed, larger rotational movements of the steering shaft 20 can be utilized. Such larger movements may be steering around a sharp corner, parking operations, and other similar pronounced navigational corrections where a broader range 56 of the operational path 50 is desired (shown in FIG. 8). Through this configuration, the controller 92 can operate the pawl assembly 150 based upon the operational parameters 52 to define the first end stop 32 and the second end stop 34. As described herein, the pawl assembly 150 operates to define the first end stop 32 and the second end stop 34 as a narrowed range 54 of the operational path 50 of the steering shaft 20 when the vehicle 12 exceeds a predetermined vehicle speed, such as a high speed setting 290. Also, the first end stop 32 and the second end stop 34 can define a broader range 56 of the operational path 50 of the steering shaft 20 when the vehicle 12 operates slower than the predetermined vehicle speed, such as a low speed setting 292. Additionally, it is contemplated that the first end stop 32 and the second end stop 34 can gradually change through a range or gradient based upon an increase or decrease in the speed of the vehicle 12.

Referring again to FIGS. 1-4 and 10, it is also contemplated that the pawl assembly 150 can interact with the ratchet assembly 30 to prevent rotational operation of the steering shaft 20 where certain exterior conditions are present. By way of example, and not limitation, where various sensors of the vehicle 12 sense the presence of an obstruction 60 (physical or virtual) near the vehicle 12, the pawl assembly 150 can interact with the ratchet assembly 30 to prevent rotation of the steering shaft 20, and, in turn, the directional wheels 44 of the vehicle 12, toward the obstruction 60. The pawl assembly 150 may interact with the ratchet assembly 30 to prevent operation of the vehicle 12 to change lanes when an obstruction 60, such as a separate vehicle, is within a blind spot of the user operating the vehicle 12. It is contemplated that the pawl assembly 150 can operate to modify the first end stop 32 and the second end stop 34 of the ratchet assembly 30 during other conditions when the vehicle 12 is in the manual state 16.

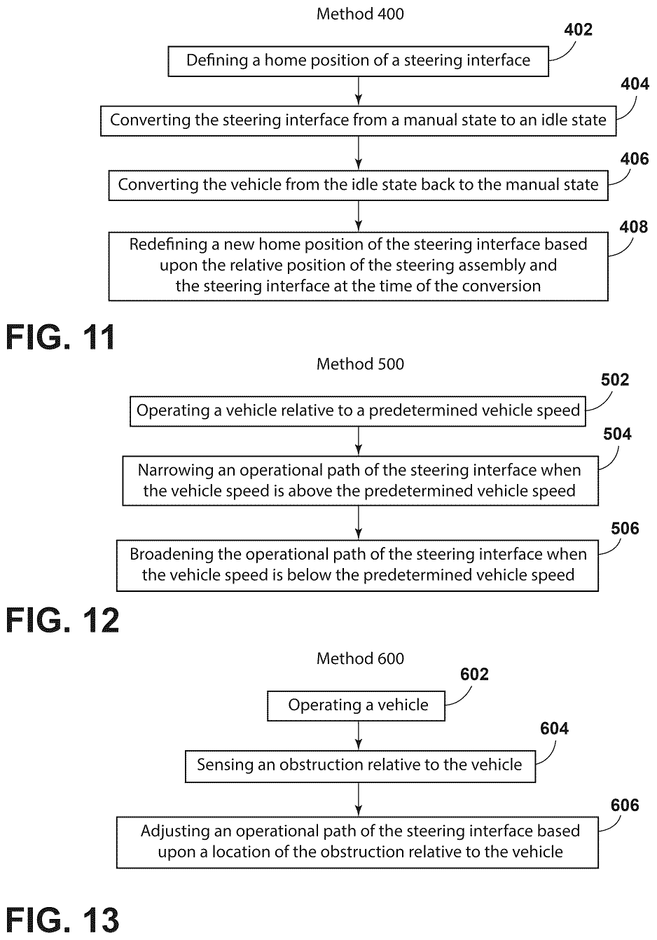

Referring now to FIGS. 1-11, having described the various aspects of the steering assembly 10, a method 400 is disclosed for operating a steering assembly 10 for a vehicle 12. According to the method 400, a step 402 includes defining a home position 310 of a steering interface 24. During operation of the vehicle 12, the steering interface 24 is converted from a manual state 16 to an idle state 18 (step 404). Subsequently, the vehicle 12 is converted from the idle state 18 back to the manual state 16 (step 406). Because of this conversion, the relative position of the steering assembly 10 with respect to a frame of the vehicle 12 is in a different position with respect to a home position 310 of the steering interface 24. Accordingly, a step 408 includes redefining a new home position 310 of the steering interface 24 based upon the relative position of the steering assembly 10 and the steering interface 24 at the time of the conversion from the idle state 18 to the manual state 16.

Referring now to FIGS. 1-10 and 12, having described various aspects of the steering assembly 10, a method 500 is disclosed for operating a steering assembly 10 for a vehicle 12. According to the method 500, a step 502 includes operating a vehicle 12 relative to a predetermined vehicle speed. Step 504 of the method 400 includes narrowing an operational path 50 of the steering interface 24 when the vehicle speed is above the predetermined vehicle speed indicative of a high speed setting 290. In this manner, large steering corrections are prevented from being taken when the vehicle 12 is moving at the high speed setting. Step 506 of the method includes broadening the operational path 50 of the steering interface 24 when the vehicle speed is below the predetermined vehicle speed indicative of a low speed setting 292. This configuration of the steering interface 24 allows for large corrections and sharp turns as the vehicle 12 moves at the low speed setting 292.

Referring now to FIGS. 1-10 and 13, having described various aspects of the steering assembly 10, a method 600 for operating a steering assembly 10 of a vehicle 12 is disclosed. According to the method 600, a step 602 includes operating a vehicle 12. Step 604 includes sensing an obstruction 60 relative to the vehicle 12. Such an obstruction 60 can be a physical object such as an object or a person. The obstruction 60 can also be a virtual obstruction, such as lines in a roadway, parking lines, and other similar obstructions or barriers. According to the method 600, a step 606 includes adjusting an operational path 50 of the steering interface 24 based upon a location of the obstruction 60 relative to the vehicle 12, where the operational path 50 is configured to avoid steering the vehicle 12 into the obstruction 60.

According to one aspect of the present disclosure, a steering system for a vehicle includes a steering shaft that rotationally operates within a housing and is operable between a manual state and an idle state, and a ratchet assembly that selectively defines a first end stop of the steering shaft and a second end stop of the steering shaft. Conversion of the steering shaft from the idle state to the manual state causes the ratchet assembly to define respective locations of the first end stop and the second end stop relative to the housing. Further, the respective locations of the first end stop and the second end stop are based upon a position of a vehicular steering assembly relative to a vehicle frame and a rotational position of the steering shaft.

According to another aspect, the steering shaft is in communication with a steer-by-wire assembly that operates at least one motor to operate the vehicular steering assembly.

According to another aspect, the ratchet assembly includes a pawl assembly that selectively engages a ratchet member, and the pawl assembly selectively engages the ratchet member when the steering shaft reaches the first end stop and, additionally, when the steering shaft reaches the second end stop.

According to another aspect, a controller is in communication with the steering shaft, the at least one motor for the vehicular steering assembly, and the pawl assembly, and the controller operates the pawl assembly to define the first end stop and the second end stop, respectively.

According to another aspect, the controller engages the pawl assembly with the ratchet member in the idle state of the steering shaft to fix the rotational position of the steering shaft relative to the housing.

According to another aspect, the steering shaft includes a steering interface, and the vehicular steering assembly includes at least one directional wheel of a plurality of road wheels.

According to another aspect, the pawl assembly includes a first pawl that selectively engages a first portion of the ratchet member to define the first end stop, and the pawl assembly includes a second pawl that selectively engages a second portion of the ratchet member to define the second end stop.

According to another aspect, the first portion of the ratchet member includes a first ratchet portion that engages the first pawl in a first rotational direction to selectively define the first end stop, and the second portion of the ratchet member includes a second ratchet portion that engages the second pawl in a second rotational direction, opposite the first rotational direction, to selectively define the second end stop.

According to another aspect, the pawl assembly is attached to the housing of the steering shaft, and the pawl assembly includes an actuating assembly that operates at least one pawl to define the first end stop and the second end stop.

According to another aspect of the present disclosure, a steering system for a vehicle includes a steering shaft that rotationally operates within a housing and is operable between a manual state and an idle state, a first ratchet member that selectively defines a first end stop of the steering shaft, and a second ratchet member that selectively defines a second end stop of the steering shaft. Conversion of the steering shaft from the idle state to the manual state causes the first ratchet member and the second ratchet member to define the first end stop and the second end stop. Further, respective locations of the first end stop and the second end stop are based upon a position of a steering assembly and a rotational position of the steering shaft.

According to another aspect, the steering shaft is in communication with a steer-by-wire assembly.

According to another aspect, the first ratchet member is a first toothed gear, and a first operable pawl selectively engages the first toothed gear when the steering shaft reaches the first end stop.

According to another aspect, the second ratchet member is a second toothed gear, and a second operable pawl selectively engages the second toothed gear when the steering shaft reaches the second end stop.

According to another aspect, a controller is in communication with the steering shaft, the steering assembly, the first pawl, and the second pawl, and the controller operates at least one of the first pawl and the second pawl to define the first end stop and the second end stop, respectively.

According to another aspect, the controller engages each of the first pawl and the second pawl with the first ratchet member and the second ratchet member, respectively, in the idle state of the steering shaft.

According to another aspect, the steering shaft includes a steering wheel.

According to another aspect, the first pawl and the second pawl are attached to the housing of the steering shaft, and the first pawl and the second pawl are attached to an actuating assembly to define the first end stop and the second end stop.

According to another aspect of the present disclosure, a steering system for a vehicle includes a steering shaft that rotationally operates to control a motor of a steer-by-wire assembly, a first ratchet portion of a ratchet assembly that selectively defines a first end stop of the steering shaft, a second ratchet portion of the ratchet assembly that selectively defines a second end stop of the steering shaft, and a pawl assembly that operates relative to the ratchet assembly to define the first end stop and the second end stop, respectively. A controller operates the pawl assembly based upon an operational parameter to define the first end stop and the second end stop. The operational parameter includes at least one of vehicle speed, a security setting, and a condition surrounding the vehicle.

According to another aspect, the first end stop and the second end stop define a narrowed operational path when the vehicle exceeds a predetermined vehicle speed, and the first end stop and the second end stop define a broader operational path when the vehicle operates slower than the predetermined vehicle speed.

According to another aspect, the narrowed operational path of the steering shaft and the broader operational path are defined through operation of the pawl assembly.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A steering system for a vehicle, the steering system comprising:
a steering shaft that rotationally operates within a housing and is operable between a manual state and an idle state; and
a ratchet assembly that selectively defines a first end stop of the steering shaft and a second end stop of the steering shaft, wherein:
conversion of the steering shaft from the idle state to the manual state causes the ratchet assembly to define respective locations of the first end stop and the second end stop relative to the housing; and
the respective locations of the first end stop and the second end stop are based upon a position of a vehicular steering assembly relative to a vehicle frame and a rotational position of the steering shaft.

2. The steering system of claim 1, wherein the steering shaft is in communication with a steer-by-wire assembly that operates at least one motor to operate the vehicular steering assembly.

3. The steering system of claim 2, wherein the ratchet assembly includes a pawl assembly that selectively engages a ratchet member, wherein the pawl assembly selectively engages the ratchet member when the steering shaft reaches the first end stop and, additionally, when the steering shaft reaches the second end stop.

4. The steering system of claim 3, wherein a controller is in communication with the steering shaft, the at least one motor for the vehicular steering assembly, and the pawl assembly, and wherein the controller operates the pawl assembly to define the first end stop and the second end stop, respectively.

5. The steering system of claim 4, wherein the controller engages the pawl assembly with the ratchet member in the idle state of the steering shaft to fix the rotational position of the steering shaft relative to the housing.

6. The steering system of claim 1, wherein the steering shaft includes a steering interface, and the vehicular steering assembly includes at least one directional wheel of a plurality of road wheels.

7. The steering system of claim 4, wherein the pawl assembly includes a first pawl that selectively engages a first portion of the ratchet member to define the first end stop, and wherein the pawl assembly includes a second pawl that selectively engages a second portion of the ratchet member to define the second end stop.

8. The steering system of claim 7, wherein the first portion of the ratchet member includes a first ratchet portion that engages the first pawl in a first rotational direction to selectively define the first end stop, and wherein the second portion of the ratchet member includes a second ratchet portion that engages the second pawl in a second rotational direction, opposite the first rotational direction, to selectively define the second end stop.

9. The steering system of claim 4, wherein the pawl assembly is attached to the housing of the steering shaft, and wherein the pawl assembly includes an actuating assembly that operates at least one pawl to define the first end stop and the second end stop.

10. A steering system for a vehicle, the steering system comprising:
a steering shaft that rotationally operates within a housing and is operable between a manual state and an idle state;
a first ratchet member that selectively defines a first end stop of the steering shaft; and
a second ratchet member that selectively defines a second end stop of the steering shaft,
wherein
conversion of the steering shaft from the idle state to the manual state causes the first ratchet member and the second ratchet member to define the first end stop and the second end stop; and
respective locations of the first end stop and the second end stop are based upon a position of a steering assembly and a rotational position of the steering shaft.

11. The steering system of claim 10, wherein the steering shaft is in communication with a steer-by-wire assembly.

12. The steering system of claim 10, wherein the first ratchet member is a first toothed gear, and wherein a first operable pawl selectively engages the first toothed gear when the steering shaft reaches the first end stop.

13. The steering system of claim 12, wherein the second ratchet member is a second toothed gear, and wherein a second operable pawl selectively engages the second toothed gear when the steering shaft reaches the second end stop.

14. The steering system of claim 13, wherein a controller is in communication with the steering shaft, the steering assembly, the first pawl, and the second pawl, and wherein the controller operates at least one of the first pawl and the second pawl to define the first end stop and the second end stop, respectively.

15. The steering system of claim 14, wherein the controller engages each of the first pawl and the second pawl with the first ratchet member and the second ratchet member, respectively, in the idle state of the steering shaft.

16. The steering system of claim 10, wherein the steering shaft includes a steering wheel.

17. The steering system of claim 15, wherein the first pawl and the second pawl are attached to the housing of the steering shaft, and wherein the first pawl and the second pawl are attached to an actuating assembly to define the first end stop and the second end stop.

18. A steering system for a vehicle, the steering system comprising:
a steering shaft that rotationally operates to control a motor of a steer-by-wire assembly;
a first ratchet portion of a ratchet assembly that selectively defines a first end stop of the steering shaft;
a second ratchet portion of the ratchet assembly that selectively defines a second end stop of the steering shaft; and
a pawl assembly that operates relative to the ratchet assembly to define the first end stop and the second end stop respectively,
wherein
a controller operates the pawl assembly based upon an operational parameter to define the first end stop and the second end stop, wherein the operational parameter includes at least one of vehicle speed, a security setting, and a condition surrounding the vehicle.

19. The steering system of claim 18, wherein the first end stop and the second end stop define a narrowed operational path when the vehicle exceeds a predetermined vehicle speed, and wherein the first end stop and the second end stop define a broader operational path when the vehicle operates slower than the predetermined vehicle speed.

20. The steering system of claim 19, wherein the narrowed operational path of the steering shaft and the broader operational path are defined through operation of the pawl assembly.
